(19) United States
(12) Patent Application Publication
(10) Pub. No.: US 2004/0130505 A1
(43) Pub. Date: Jul. 8, 2004

(54) DISPLAY DEVICE CAPABLE OF PROCESSING USB DATA

(76) Inventors: Meng-Che Lee, Tai-Chung City (TW); Ta-Lin Tseng, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/605,971

(22) Filed: Nov. 11, 2003

(30) Foreign Application Priority Data
Jan. 7, 2003 (TW) 092100270

(51) Int. Cl. G09G 3/00

(52) U.S. Cl. 345/30

(57) ABSTRACT

An image-displaying device for displaying images has a housing, an universal serial bus port installed in the housing for electrically connecting to an electronic device through an universal serial bus in order to receive serial data, a data converter installed in the housing and electrically connected to the universal serial bus port for converting the serial data to image data, an image processor installed in the housing and electrically connected to the data converter for converting the image data to display data, and an image generator installed in the housing and electrically connected to the image processor for displaying an image on a display according to the display data.

### BACKGROUND OF INVENTION

1. Field of the Invention

The present invention relates to a display device, and more specifically, to a display device capable of processing universal serial bus (USB) data.

2. Description of the Prior Art

Display devices, such as projectors and monitors, are one of the most important output devices among various peripheral components. Generally, analog image data in different formats, such as that in the NTSC format, is inputted into the display device through an external signal source, such as a personal computer, and is converted to display data displayed by the display device thereafter.

Please refer to FIG. 1 showing a functional block diagram of a projector 10 according to the prior art. As shown in FIG. 1, the projector 10 comprises a housing 12, an analog-to-digital converter (A/D converter) 14 installed in the housing 12 and electrically connected to an external signal source 16 to receive an analog image data and convert the analog image data to a display image data in a digital format, such as in the RGB888 format or the YUV422 format, a scaler 18 installed in the housing 12 and electrically connected to the A/D converter 14 to receive display data in the digital format and scale the display data, and a driver 20 installed in the housing 12 and electrically connected to the scaler 18 for generating a driving signal to drive a display panel 22 and display the scaled display data on a screen (not shown in FIG. 1) by utilizing a light source 24 after the display data is scaled.

Alternatively, the projector 10 can be replaced by a monitor, such as a liquid crystal display (LCD) monitor, which is similar to the projector 10 in composition and function, except that the monitor utilizes a light source generated by a display panel to display the image.

As technologies progress, personal computers become tools employed not only in document and mathematical data processing but also in multimedia data processing. Numerous multimedia-related peripheral components, such as digital image storage devices including digital cameras and digital camcorders, have been developed and have become the most popular products in the market for their full-ranged functions and easiness in operation. These digital image storage devices store captured images in a memory device, such as a CF card or a SD card, in digital formats, such as the JPG format. By electrically connecting the digital image storage device to a universal serial bus (USB) port of a computer with either a USB bus or a memory card reader compatible with the digital image storage device and capable of being connected to the USB port, a user can convert the image data to a serial data and transmit the serial data to the computer for storage, display, or further image processing. In addition, the user can turn the serial data back into the image data by utilizing software compatible with the digital image storage device.

However, as mentioned in the preceding paragraphs, the display device according to the prior art can only display the images captured by the digital image storage devices after the image is processed under various and complicated procedures including downloading the image data through the USB bus to the computer, converting the image data to an analog image data by the computer, and transmitting the analog image data to the display device. The user needs to spend more time on the operation of the related devices, as well as more money on the purchase of the computer for the purpose of displaying captured images. As a result, the display device according to the prior art is a less competitive product in the market.

### SUMMARY OF INVENTION

It is therefore a primary object of the present invention to provide a display device capable of processing universal serial bus (USB) data, so as to receive and process image data through a USB without utilizing a computer.

According to the claimed invention, the display device comprises a housing, a USB port installed in the housing and electrically connected to an electronic device through a USB to receive serial data, a data converter installed in the housing and electrically connected to the USB port for converting the serial data to image data, an image processor installed in the housing and electrically connected to the data converter for converting the image data to display data, and an image generator installed in the housing and electrically connected to the image processor for displaying an image on a screen according to the display data.

It is an advantage of the present invention over the prior art that the USB port, the data converter, and the image processor are integrated in the display device, so that the image data stored in the electronic device can be directly input into the display device through the USB and displayed by the display device without utilizing a computer for the processing and converting of the image. Consequently, the procedure for displaying the image is simplified, and cost spent on the purchase of the computer is saved as well.

These and other objectives of the present invention will no doubt become obvious to those of ordinary skill in the art after reading the following detailed description of the preferred embodiment, which is illustrated in the multiple figures and drawings.

### BRIEF DESCRIPTION OF DRAWINGS

FIG.1 is a functional block diagram of a projector according to the prior art.

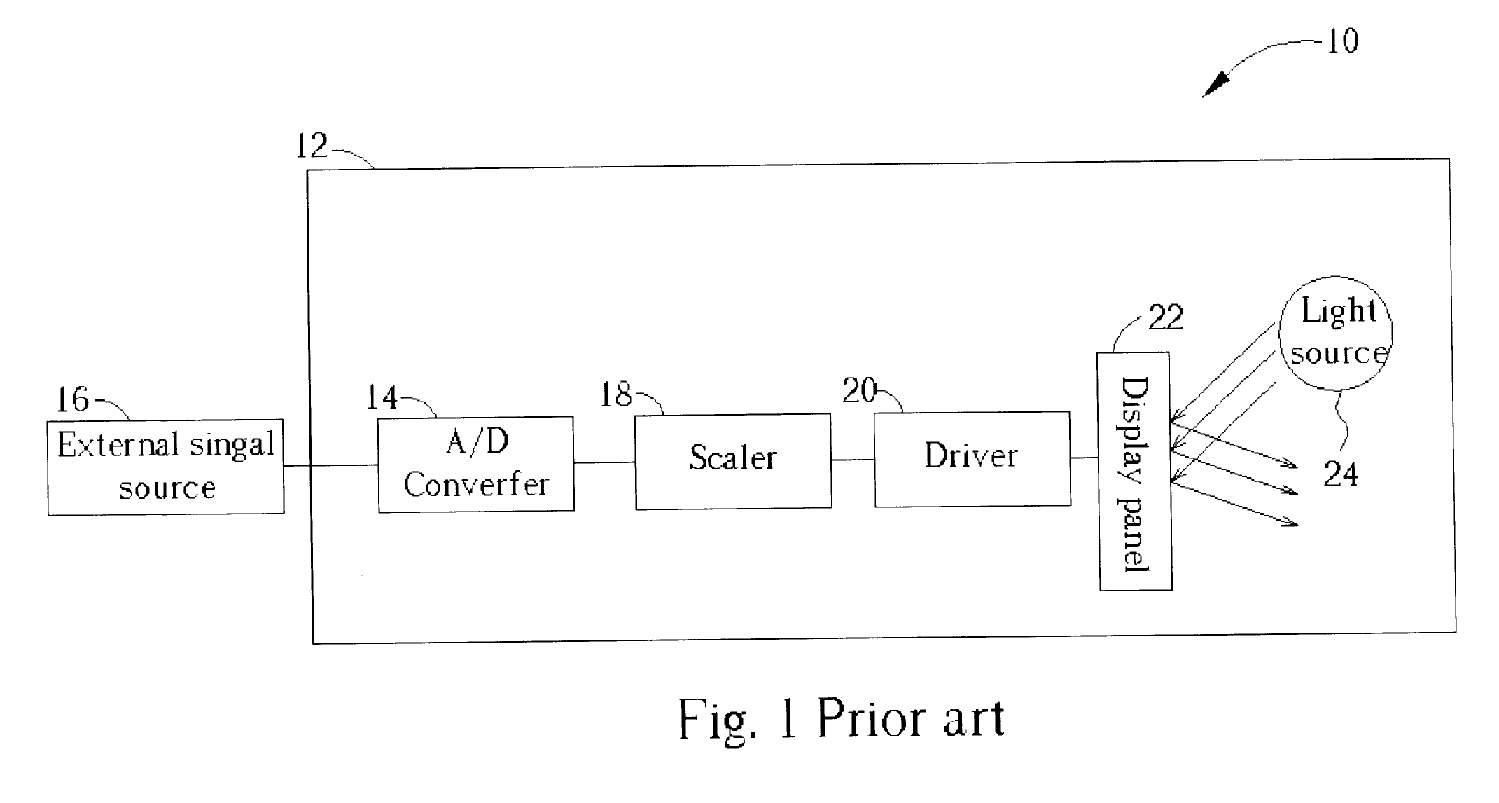

FIG.2 is a functional block diagram of a display device according to the present invention.

### DETAILED DESCRIPTION

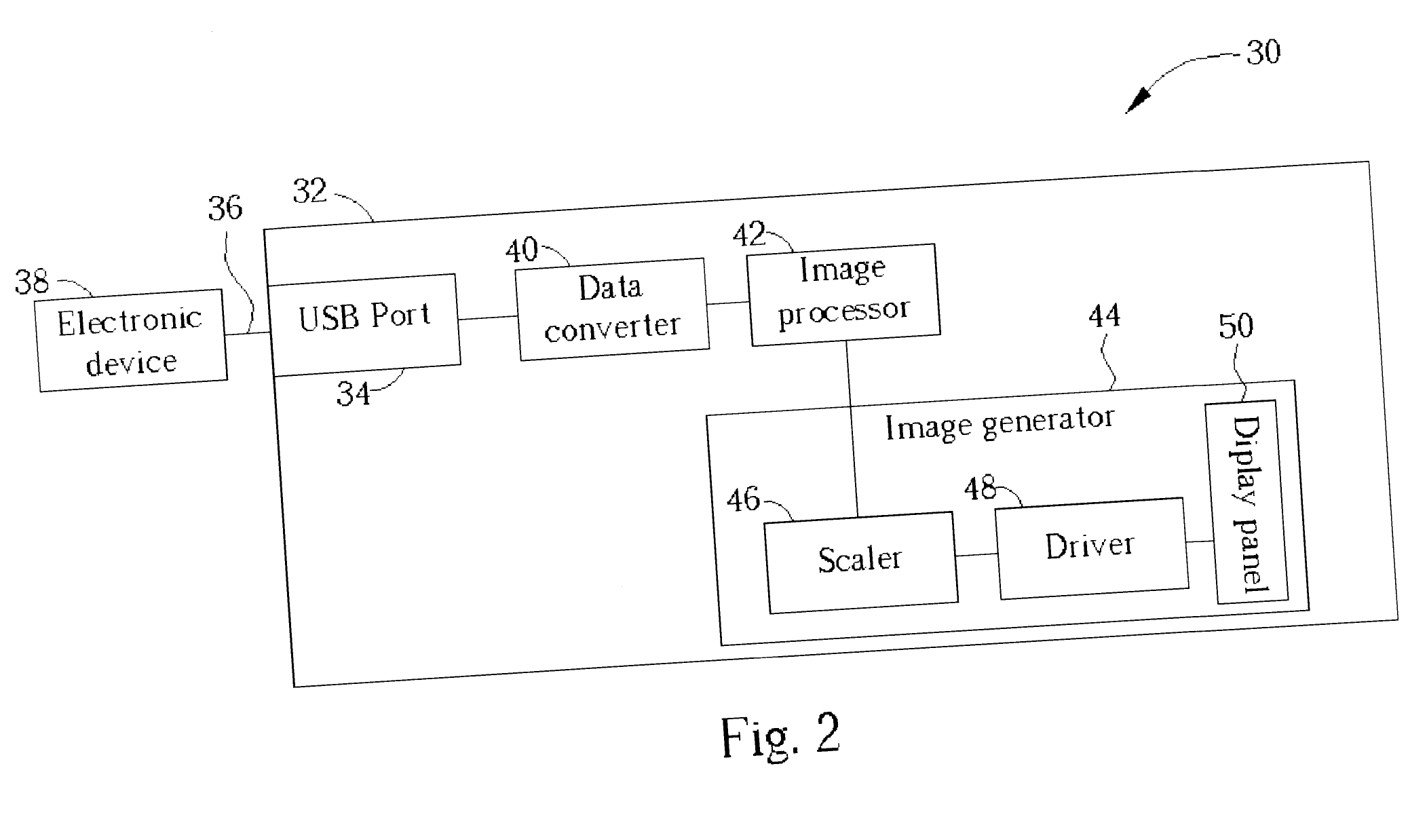

Please refer to FIG. 2 showing a functional block diagram of a display device 30 according to the present invention. As shown in FIG. 2, the display device 30 comprises a housing 32, a universal serial bus (USB) port 34 installed in the housing 32 for electrically connecting to an electronic device 38 through a USB cable 36 to receive serial data, a data converter 40 installed in the housing 32 and electrically connected to the USB port 34 for converting the serial data to image data, an image processor 42 installed in the housing 32 and electrically connected to the data converter 40 for converting the image data to display data, and an image generator 44 installed in the housing 32 and electrically connected to the image processor 42 for displaying an image on a screen (not shown in FIG. 2) according to the display data.

In the embodiment of the present invention, the image generator 44 comprises a scaler 46 installed in the housing 32 and electrically connected to the image processor 42, and a driver 48 installed in the housing 32 and electrically connected to the scaler 46. The scaler 46 is employed to scale the display data, and the driver 48 is employed to generate a driving signal for driving a display panel 50 to display the display data scaled by the scaler 46 on the screen.

The serial data is input into the display device 30 from the electronic device 38 through the USB cable 36 and the USB port 34. Generally, the electronic device 38 is either a digital image storage device, such as a digital camera or a digital camcorder, or a memory card reader capable of reading data stored in a memory card, and the serial data is converted from the image data according to the USB specification. The data converter 40 is employed to convert the received serial data back to the original image data according to the USB specification, and the image processor 42 is employed to convert the image data to display data in a digital format, such as the RGB888 format or the YUV422 format, by utilizing software, which is stored in the image processor 42, compatible to the electronic device 38.

The display data is then transmitted to the scaler 46 of the image generator 44. Finally, by utilizing the scaler 46, the driver 48 and the display panel 50, the image is displayed on the screen according to the display data. In the preferred embodiment of the present invention, the display device 30 is a projector, and a light source generator (not shown) is utilized to provide a light source on the display panel 50 so as to reflect the image on the screen. In another embodiment of the present invention, the display device 30 is a liquid crystal display (LCD) monitor, and the display panel 50 is the screen itself and is capable of generating the light source to display the image thereon.

Alternatively, the image data can be inputted into the display device 30 in an analog format, such as in an NTSC format, from an external signal source, such as a personal computer, and the image generator 44 comprises an analog-to-digital converter (A/D converter) for converting the image data to display data in the digital format.

In comparison with the prior art, the USB port 34, the data converter 40 and the image processor 42 are integrated in the display device 30, so that the image data stored in the electronic device 38 can be directly input into the display device 30 through the USB cable 36 and displayed by the display device 30 without utilizing a computer for processing and converting the image. Consequently, the procedure for display the image is simplified, and cost spent on the purchase of the computer is saved as well.

Those skilled in the art will readily observe that numerous modifications and alterations of the device may be made while retaining the teachings of the invention. Accordingly, the above disclosure should be construed as limited only by the metes and bound of the appended claims.

What is claimed is:

1. A display device for displaying images, the display device comprising:
a housing;
an USB port installed in the housing, the USB port for electrically connecting to an electronic device to receive serial data;
a data converter installed in the housing and electrically connected to the USB port, the data converter for converting the serial data to image data;
an image processor installed in the housing and electrically connected to the data converter, the image processor for converting the image data to display data; and
an image generator installed in the housing and electrically connected to the image processor, the image generator for displaying an image on a screen according to the display data.

2. The display device of claim 1 wherein the USB port is adapted to connecting to a digital camera through an USB cable.

3. The display device of claim 1 wherein the USB port is adapted to connecting to a digital camcorder through an USB cable.

4. The display device of claim 1 wherein the USB port is adapted to connecting to a memory card reader through an USB cable.

5. The display device of claim 1 wherein the image processor is capable of converting the image data to display data having an RGB888 format.

6. The display device of claim 1 wherein the image processor is capable of converting the image data to display data having a YUV422 format.

7. The display device of claim 1 wherein the image generator comprises:
a scaler electrically connected to the image processor to receive the display data, the scaler for scaling the display data; and
a driver electrically connected to the scaler for generating a driving signal after the scaler has scaled the display data, so as to display the scaled display data on the screen.

8. The display device of claim 7 wherein the image generator further comprises an analog-to-digital converter connected between an external signal source and the scaler, the analog-to-digital converter for converting analog image data inputted from the external signal source to the display data, so as to transmit the display data to the scaler.

9. The display device of claim 8 wherein the analog-to-digital converter is connected between a personal computer and the scaler.

10. The display device of claim 1 being a projector, the projector further comprising a light source for providing light, so as to project the scaled display data on the screen.

11. The display device of claim 1 being capable of displaying images on a monitor.
